(19) United States
(12) Patent Application Publication
(10) Pub. No.: US 2008/0089820 A1
(43) Pub. Date: Apr. 17, 2008

(54) Method and Device for Providing Ammonia in an Exhaust Gas Flow of an Internal Combustion Engine

(75) Inventor: Eberhard Jacob, Krailling (DE)

Correspondence Address: LERNER GREENBERG STEMER LLP, P O BOX 2480, HOLLYWOOD, FL, 33022-2480, US

(73) Assignee: EMITEC GESELLSCHAFT FüR EMISSIONSTECHNOLOGIE MBH, Lohmar (DE)

(21) Appl. No.: 11/949,304

(22) Filed: Dec. 3, 2007

Related U.S. Application Data
(63) Continuation of application No. PCT/EP2006/005259, filed on Jun. 2, 2006.

(30) Foreign Application Priority Data
Jun. 3, 2005 (DE) DE102005026036.5

(51) Int. Cl. C01C 1/02

(52) U.S. Cl. 423/212; 423/352; 422/148

(57) ABSTRACT

A method for providing ammonia (NH₃) in an exhaust gas flow of an internal combustion engine includes generating nitrogen monoxide (NO) with a plasma generator, reversibly storing at least a portion of the nitrogen monoxide (NO), reducing at least a portion of the stored and/or generated nitrogen monoxide (NO) to form ammonia (NH₃) in a first gas flow, and mixing the first gas flow with the exhaust gas flow. The method and a device for reducing nitrogen oxides advantageously increase the efficiency of an on-board plasma-assisted generation of ammonia, particularly for mobile applications, such as in motor vehicles, and reduces the consumption of fuel required therefor, in comparison to prior art devices and methods.

### CROSS-REFERENCE TO RELATED APPLICATION

This is a continuing application, under 35 U.S.C. § 120, of copending International Application No. PCT/EP2006/005259, filed Jun. 2, 2006, which designated the United States; this application also claims the priority, under 35 U.S.C. § 119, of German Patent Application DE 10 2005 026 036.5, filed Jun. 3, 2005; the prior applications are herewith incorporated by reference in their entirety.

### BACKGROUND OF THE INVENTION

### Field of the Invention

The subject matter of the present invention is a method and a device for providing ammonia in the exhaust gas of an internal combustion engine, in which it is possible for ammonia to be used as a selective reducing agent that is generated on board, for the reduction of the nitrogen oxides. The method is to be particularly advantageously used for providing a selective reducing agent for the selective catalytic reduction of nitrogen oxides in the exhaust gas of a passenger vehicle with an internal combustion engine.

The exhaust gas of internal combustion engines contains a multiplicity of substances that also include those which, in excessively high concentrations, have negative consequences for living organisms and/or the inanimate environment. There are limit values which must be adhered to in many countries, in order to reduce the effects, for example, of the ever-increasing amount of traffic as well as the ever-increasing number of power plants for energy and/or heat generation.

The undesired emissions also include nitrogen oxides (NO_{X}). Nitrogen oxides can be reduced to molecular nitrogen (N₂). That can take place, for example, through the use of a selective reducing agent. In the exhaust gas, in particular of diesel internal combustion engines, which generate an exhaust gas flow that has a very high oxygen content, the use of a selective reducing agent is often necessary, since a non-selective reduction would initially reduce the oxygen. For that reason, a multiplicity of selective reducing agents for the selective catalytic reduction of nitrogen oxides (NO_{X}) has been proposed. Those include, for example, ammonia or ammonia precursors such as for example urea. However, ammonium carbamate, isocyanuric acid and cyanuric acid are also known. In the automotive sector, the use of urea, in particular, as an ammonia precursor is widely implemented. For that purpose, it is known, in particular in the field of utility vehicles, to use an aqueous ammonia solution that is passed to a hydrolysis catalytic converter in which the urea is hydrolyzed to form ammonia. The ammonia is used in a honeycomb body with a corresponding SCR (selective catalytic reduction of nitrogen oxides) coating as a selective reducing agent. That has the disadvantage that, on one hand, an additional tank is necessary in which the reducing agent or the reducing agent precursor such as for example urea solution is stored. In addition, the tank must be filled regularly meaning that as widespread and dense a network as possible of supply stations for the urea solution is necessary. The construction of a system of that type is, like the operation, very expensive and service-intensive. In addition, during continued operation of the internal combustion engine after the urea solution storage has been used up, effective reduction of the nitrogen oxides no longer takes place. The nitrogen oxides are discharged to the atmosphere.

For that reason, it has already been proposed to generate a reducing agent on board. In that regard, a method is known, for example, from German Published, Non-Prosecuted Patent Application DE 102 58 185 A1, corresponding to U.S. Patent Application Publication No. US 2004/0168905 A1, in which nitrogen oxides are generated through the use of a plasma-assisted method, and the nitrogen oxides are reduced to form ammonia with the addition of hydrogen-containing gas. The ammonia which is thus formed can be used as a reducing agent. In addition, German Published, Non-Prosecuted Patent Application DE 102 58 185 A1, corresponding to U.S. Patent Application Publication No. US 2004/0168905 A1, discloses a corresponding plasma generator. The formation of the nitrogen oxides takes place in a gas mass flow which is small in relation to the exhaust gas mass flow of the corresponding internal combustion engine. The plasma generator generates a gas discharge which heats the operating gas of the plasma generator to temperatures of over 2000 K. The use of hydrocarbons, which are generally extracted from the fuel of the internal combustion engine, is proposed therein in order to reduce the nitrogen oxides to form ammonia. That leads to an increased fuel consumption when using the method.

### SUMMARY OF THE INVENTION

It is accordingly an object of the invention to provide a method and a device for the on-board provision of ammonia in an exhaust gas flow of an internal combustion engine, which overcomes the hereinafore-mentioned disadvantages of the heretofore-known devices and methods of this general type and in which a fuel quantity required for providing the ammonia is reduced.

With the foregoing and other objects in view there is provided, in accordance with the invention, a method for providing ammonia for the reduction of nitrogen in an exhaust gas flow of an internal combustion engine. The method comprises:
a) generating nitrogen monoxide with a plasma generator;
b) reversibly storing at least a part of the nitrogen monoxide;
c) reducing at least a part of the stored and/or generated nitrogen monoxide to form ammonia in a first gas flow; and
d) mixing the first gas flow with the exhaust gas flow.

It is possible, in particular, for steps a) and c) to be carried out offset with respect to one another in terms of time. That is to say, the generation of a gas flow including nitrogen monoxide with a plasma generator can be separated in terms of time and/or space from the reduction of the nitrogen monoxide to form ammonia in the first gas flow, since the reversible storage of at least a part of the nitrogen monoxide in the first gas flow makes it possible for a storage device for nitrogen oxides to initially be filled with the nitrogen monoxide, and for that storage device to be emptied again in a later step in order to reduce the stored nitrogen monoxide to form ammonia. That has advantages, in particular, when the generation of a gas flow including nitrogen monoxide with a plasma generator takes place, as is described in German Published, Non-Prosecuted Patent Application DE 102 58 185 A1, corresponding to U.S. Patent Application Publication No. US 2004/0168905 A1, since there, air is preferably used for generating the first gas flow. Although the oxygen content of the air is reduced by the generation of nitrogen monoxide from the molecular nitrogen (N₂) of the air, for example to approximately 19%, the very high oxygen proportion would, however, lead, during the addition of hydrocarbons or hydrogen as a reducing agent for the reduction of nitrogen monoxide to form ammonia, to an oxidation of the hydrocarbons by the remaining air oxygen initially taking place. That, however, has the effect that the proportion of added hydrocarbons or hydrogen must be increased to such an extent that initially the air oxygen reacts, and then a reduction of the nitrogen monoxide to form ammonia takes place subsequently. As a result of the reversible storage of the nitrogen monoxide according to the invention, the reduction of the nitrogen monoxide can take place in a state in which the oxygen proportion of the first gas flow is as small as possible. An alternating mode is for example possible, where in a first phase, the nitrogen monoxide is initially generated and reversibly stored, while in a second phase with a first gas flow with as low an oxygen content as possible, for example at a certain hydrogen proportion of the gas flow, a reduction of the nitrogen monoxide to form ammonia takes place. It is possible, in particular, for a plurality of storage processes to take place in storage elements which are operated in parallel. The storage elements are in each case filled with nitrogen monoxide intermittently by a single plasma generator.

Since no oxidation of the hydrogen takes place here, but rather the hydrogen is used directly for the reduction of nitrogen monoxide, the use of hydrogen, and therefore the use of hydrocarbons when generating the hydrogen from hydrocarbons, can thus be significantly reduced. In the case of a use in mobile or also in stationary exhaust gas systems of internal combustion engines, it is thus possible, with identical nitrogen oxide reduction, for the increased fuel consumption for providing ammonia through the use of oxidation of nitrogen monoxide to be significantly reduced.

The reversible storage can take place, in particular, through the use of a sorption, for example a chemisorption and/or physisorption at a correspondingly-formed storage element. The term “reversible storage” is to be understood, in particular, to mean a storage of nitrogen oxides as nitrogen oxides or fundamentally as a nitrogen compound such as for example in the form of a nitrite, nitrate or a metal complex which, by changing a process variable, can be made reversible again, or in which the nitrogen compound can be released again from the coating through the use of a chemical reaction. An at least partial provision or release of the stored nitrogen oxide can take place through the use of a corresponding change of the process variable. A substantially reversible storage is to be understood to mean that there can be a certain proportion of nitrogen oxide which is permanently stored and is no longer provided or released. A storage, provision and release of nitrogen oxides is to be understood within the context of this invention to mean that nitrogen oxides are stored in molecular form or in the form of a nitrogen-containing chemical compound, and are released again in molecular form or as a nitrogen-containing chemical compound.

Step c) takes place in particular through the use of a hydrogen-containing gas. This can preferably include a cracked gas which can be obtained from the fuel of the internal combustion engine through the use of partial oxidation.

The storage can, for example, take place through the use of a physisorption after partial or complete oxidation of the NO to form NO₂ at a platinum oxidation catalytic converter with zeolites. The storage is reversible by virtue of a limit temperature being exceeded or undershot. A chemisorption can, for example, take place by reaction with corresponding components of a storage coating of a storage element in which, for example, the nitrogen monoxide is stored in the form of a nitrite, nitrate or in the form of a metal complex.

With regard to the construction and the operation of the plasma generator, reference is made to German Published, Non-Prosecuted Patent Application DE 102 58 185 A1, corresponding to U.S. Patent Application Publication No. US 2004/0168905 A1, the content of the disclosure of which in this respect is hereby incorporated by reference in this application.

The ammonia which is provided can be used, in particular, as a reducing agent for the reduction of nitrogen oxides in the exhaust gas flow. Therefore, a method which is preferable is a method for the reduction of nitrogen oxides in an exhaust gas flow of an internal combustion engine which, in addition to the above-specified method steps a) to d), also includes the following additional method step:

e) reduction of nitrogen oxides (NO_{X}) in the exhaust gas flow through the use of

ammonia (NH₃).

Method step e) takes place, in particular, in a honeycomb body which is provided with a corresponding coating.

In accordance with another mode of the invention, the operating gas of the plasma generator includes a partial flow of the exhaust gas flow. The operating gas is understood to mean the starting material gas of the plasma generator. Alternatively or in addition, the operating gas can include an oxygen-containing gas. In this case, it is particularly preferable for air to be at least added. This means that air on one hand can be added to an exhaust gas partial flow, and that on the other hand air can be used substantially exclusively as an operating gas for the plasma generator. Air contains sufficient quantities of both nitrogen as well as the oxygen which is required for the partial oxidation, so that as great a yield of nitrogen monoxide as possible can be generated with the operation of the plasma generator with air with corresponding operating parameters of the generator. The selection of whether an exhaust gas partial flow, in particular an exhaust gas partial flow which includes a smaller mass flow than the main exhaust gas flow, or air is used as the operating gas of the plasma generator, can be made in particular by the ultimately expected required quantity of ammonia. The air proportion of the operating gas and/or the proportion of exhaust gas in the operating gas of the plasma generator can be controllable or regulable, for example through the use of a corresponding supply and/or flow guiding device upstream of the plasma generator. The operating gas can preferably be introduced pre-warmed into the plasma generator.

In accordance with a further mode of the invention, an at least partial provision and/or release of the stored nitrogen monoxide in the first gas flow takes place before and/or during step c).

In particular, an at least partial chemisorption of the nitrogen monoxide is possible through the use of the formation of nitrite and/or nitrate groups and a corresponding release through the use of a chemical reaction. The embedding takes place, for example, through the use of corresponding reaction partners on the storage element, with which compounds are entered into, that form nitrite (NO₂) groups and nitrate (NO₃) groups. This can take place, for example, in the form of a corresponding coating of a corresponding storage element. If the storage element is now traversed by a hydrogen-containing gas in step b), then the nitrite groups are converted with hydrogen to form ammonia, water and OH groups. The same applies to the nitrate groups:
NO₂⁻+3H₂→NH₃+OH⁻+H₂O
NO₃⁻+4H₂→NH₃+OH⁻+2H₂O

In addition, step b) can take place, for example, in a metal-exchanged zeolite, in which the nitrogen oxides are embedded in the form of corresponding metal complexes in zeolites and can likewise be released through the use of a corresponding chemical reaction. In addition, the storage can take place as a nitrate and/or nitrite in NSR (nitrogen storage and reduction) catalytic converters, which have a corresponding coating. It is also possible, in particular, for the at least partial provision and/or release of the stored nitrogen monoxide to take place at the same time as step c). For this purpose, it is possible, in particular, for a corresponding storage element to be formed in which, on one hand, a physisorption and/or chemisorption of the nitrogen monoxide takes place and which, on the other hand, catalyzes a corresponding reduction of the nitrogen monoxide. This can take place, for example, by providing a corresponding storage reduction coating in which the nitrogen monoxide is stored as a nitrite and/or a nitrate group. If hydrogen-containing gas is now conducted through the storage element, a corresponding reduction takes place, as described above, to form ammonia, as a result of which a release of the nitrogen monoxide from the storage element and therefore an at least partial provision of the stored nitrogen oxide in the first gas flow takes place. In this case, the reduction to form ammonia also takes place at the same time.

In accordance with an added mode of the invention, the substantially reversible storage of at least a part of the nitrogen monoxide takes place in a storage element.

Honeycomb bodies which are provided with a corresponding coating are particularly suitable as storage elements. Honeycomb bodies, at a relatively small volume, have a relatively large specific surface, which can be provided as a storage device for nitrogen monoxide. A honeycomb body is understood, in particular, to mean ceramic and/or metallic honeycomb bodies. Ceramic honeycomb bodies can be extruded from a ceramic mass and be provided in fired form, while metallic honeycomb bodies can, for example, be produced by winding and/or twisting metallic layers. It is possible, in particular, for a part of the layers or else one layer to be at least partially structured. In this case, the term structured is to be understood to mean the formation of structures within the layer which, during the winding and/or twisting of the layers, lead to the formation of cavities that can be traversed by flow, for example channels or ducts, in the honeycomb body, and at least partially delimit the channels or ducts. In this case, on one hand, the formation of a substantially spiral-shaped honeycomb body in which, for example, at least one substantially smooth and at least one at least partially structured metallic layer are wound with one another in a spiral shape, is particularly preferable. It is also preferable to form the honeycomb body by stacking substantially smooth and at least partially structured metallic layers, with one or more stacks composed of a plurality of layers being wound with one another in the same sense or in opposite senses. A substantially smooth layer is also understood to mean a layer which has a microstructure having an amplitude which is smaller, preferably significantly smaller, than the amplitude of the structuring in at least partially structured layers.

In this case, a metallic layer is understood to mean, in particular, sheet metal foils and layers, which can be at least partially traversed by a fluid such as for example fibrous layers or corresponding sintered layers. According to the invention, metallic layers are also understood to mean composite layers in which, for example, thin sheet metal strips, for reinforcing the layers that can be at least partially traversed by a fluid, are connected to the layers.

Preferred thicknesses of the metallic layers, for example in the case of sheet metal foils, lie in the range of approximately 160 μm and lower, preferably in the range of substantially 80 μm and lower, particularly preferably in the range from approximately 15 to approximately 50 or else approximately 30 to substantially 40 μm. The metallic layers which can be at least partially traversed by a fluid have, in particular, a thickness of 3 mm or lower, preferably of 2 mm or lower, particularly preferably from approximately 0.1 to approximately 1.5 or else from approximately 0.5 mm to approximately 1 mm.

The honeycomb bodies have a storage coating at which the combination of nitrogen monoxide or else generally of nitrogen oxides through the use of physisorption and/or chemisorption, takes place. In this case, it is for example possible for the storage coating to have a zeolite which has such a channel or duct and/or cage structure that nitrogen oxides are embedded at temperatures below a limit temperature, and the nitrogen oxides are released again when a second limit temperature is exceeded. In this case, a coating is preferable which includes iron-exchanged zeolites.

On the other hand, the coating can also include alkaline substances with which nitrogen monoxide reacts to form nitrites and/or nitrates. It is possible, in particular, for the storage element or the honeycomb body to also include a storage reduction coating in which nitrogen oxides are correspondingly temporarily stored and, when for example a hydrogen-containing gas flows through the honeycomb body, a reaction of the nitrogen monoxide with the gas takes place. A reaction can take place not only with nitrogen monoxides or nitrogen oxides but also with corresponding nitrogen-oxide-releasing substances such as, for example, nitrite and/or nitrate groups.

In accordance with an additional mode of the invention, the storage takes place through the use of physisorption and/or chemisorption.

In this case, chemisorption through the use of the formation of nitrite and/or nitrate groups is particularly preferred. If a physisorption of the nitrogen oxides takes place, it is preferable to carry out the desorption of the nitrogen oxides by heating the storage element above a limit temperature. The heating can be realized, in particular, as electrical resistance heating.

The storage element can preferably also be constructed in such a way that a physisorption takes place at the same time as a chemisorption or that the physisorption and chemisorption take place in two temperature ranges which overlap one another. It is thus possible, in particular, for a physisorption to take place at low temperatures at which the minimum temperature from which the chemisorption takes place has not yet been reached. When an upper limit temperature is exceeded, a desorption of the physisorbed proportion takes place.

In accordance with yet another mode of the invention, a hydrogen-containing gas is used in step b).

Hydrogen reduces nitrogen monoxide to form ammonia. It is possible, in particular, for the hydrogen-containing gas to be a cracked gas or synthesis gas which is generated through the use of partial oxidation of hydrocarbons. It is thus possible, in particular, to dispense with the storage of a further reducing agent to form the ammonia, since hydrocarbons are generally stored as fuel for the operation of the internal combustion engine.

In accordance with yet another mode of the invention, the hydrogen-containing gas is generated from a hydrocarbon-containing starting material. This can particularly preferably be the fuel with which the internal combustion engine is operated.

In accordance with yet a further mode of the invention, the storage of at least a part of the nitrogen monoxide takes place in two storage elements which are operated in parallel, with in each case a first storage element temporarily storing nitrogen monoxide, and a second storage element providing nitrogen monoxide to the first gas flow, and/or nitrogen oxides being released from the second storage element.

A method is thus preferred in which two gas lines that can be operated in parallel are provided. In a first gas line, steps a) and b) of the method are carried out, while step c) is carried out in parallel in a second gas line with the stored nitrogen monoxide. The method is, in particular, configured in such a way that only steps a) and b) are carried out in a first gas line, while only step c) is carried out in the second gas line. It is possible, in particular, when carrying out step c) in one gas line for the gas line to be traversed by a gas mixture with as low an oxygen content as possible in order to prevent a reaction with oxygen. This advantageously reduces the use of hydrocarbons and therefore the fuel consumption when generating a cracked gas or synthesis gas from the fuel of the internal combustion engine. It is now possible, in particular, for the plasma generator to be operated continuously and in each case to fill one of the two storage elements while the other storage element is presently being emptied.

The method according to the invention fundamentally also makes it possible to use the stored quantity of nitrogen monoxide as a reserve for sudden nitrogen oxide concentration peaks in the exhaust gas. It is possible for a certain buffer of nitrogen monoxide and therefore also reducing agent for the reduction of nitrogen oxide concentrations in the exhaust gas of the internal combustion engine to be held ready in the storage element. The buffer can be quickly added in the case of a suddenly-rising nitrogen oxide concentration in the exhaust gas. In this case, the inertia of the nitrogen oxide generation by the plasma generator is bypassed. The function can alternatively or additionally be provided for selective operation and an alternating sorption and desorption of nitrogen oxides on the one or the plurality of storage elements. It is particularly possible and advantageous to form the storage element or elements with a storage capacity which is greater than the minimum storage capacity that is to be provided for a permanent provision of ammonia. That is to say that, for permanent operation and a continuous output of ammonia, a certain capacity X for storing nitrogen monoxide must be present which permits a continuous output of ammonia of a certain concentration. It is advantageous for the storage element or elements to be formed with a capacity of Y for storing nitrogen oxides, with Y being greater than X. The difference between Y and X can then be used as a buffer which can be used if the exhaust gas has sudden nitrogen oxide peaks. An operating method in which the nitrogen oxide concentration in the exhaust gas is monitored directly or indirectly as continuously as possible or else at least at the shortest possible time intervals, is also preferable herein. In this case, it is possible to determine the gradient of the concentration from the measured nitrogen oxide concentration values in the exhaust gas, and to predict, on the basis of the gradient, how high the demand for ammonia for as complete a reduction as possible of the nitrogen oxides in the exhaust gas is in a certain timespan. The plasma generator and the storage elements are then correspondingly operated on the basis of the demand so that, where possible, a corresponding quantity of ammonia can be provided. This means, for example, that due to the increase, a sharp rise in the nitrogen oxide concentration in the exhaust gas is predicted. Thereupon, the plasma generator on one hand is correspondingly operated in order to generate sufficient ammonia where possible, and on the other hand, a correspondingly provided ammonia or nitrogen monoxide storage is emptied in order to thus also be able to briefly increase the ammonia production from the sources. It is thus advantageously possible to intercept, in particular, fast changes in the nitrogen oxide concentration in the exhaust gas.

With the objects of the invention in view, there is also provided a device for providing ammonia in the exhaust gas of an internal combustion engine. The device comprises at least one plasma generator for generating nitrogen monoxide. At least one first reduction device is to be connected to the plasma generator for the reduction of nitrogen monoxide to form ammonia. At least one storage element is provided for storing nitrogen monoxide. The at least one storage element is disposed between the at least one plasma generator and the at least one first reduction device. The device according to the invention is, in particular, also suitable for carrying out the method according to the invention.

In accordance with another feature of the invention, in addition, a second reduction device can additionally be provided which serves for the selective reduction of nitrogen oxides (NO_{X}) and which can be connected to the first reduction device.

It is possible, in particular through the use of the device according to the invention, for the fuel consumption to be reduced when using hydrocarbons as a reducing agent for the reduction of nitrogen oxides to form ammonia or when using hydrocarbons as a precursor of reducing agents for nitrogen monoxide to form ammonia, since a device of this type makes it possible to provide nitrogen oxide without the storage element being traversed by oxygen-containing gas that is generally obtained when generating the nitrogen monoxide through the use of a plasma generator. The reducing agent in the first reduction device therefore does not react with the oxygen, but rather predominantly with the nitrogen monoxide. The fuel consumption is thus lowered.

In accordance with a further feature of the invention, the at least one storage element is preferably constructed as a honeycomb body with a storage coating.

Reference is made to the statements made above for the definition of a honeycomb body. It is also possible, in particular, for the first and/or the second reduction device to be constructed as a honeycomb body with a corresponding coating. The plasma generator can preferably be constructed and/or operated as in German Published, Non-Prosecuted Patent Application DE 102 58 185 A1, corresponding to U.S. Patent Application Publication No. US 2004/0168905 A1, the entire content of which is hereby incorporated herein at least with regard to the construction and the mode of operation of the plasma generator, and with regard to the construction of the electrodes and/or the process parameters for operating the plasma generator. This applies, in particular, also to the shapes of the electrodes as are disclosed in German Published, Non-Prosecuted Patent Application DE 102 58 185 A1, corresponding to U.S. Patent Application Publication No. US 2004/0168905 A1.

In accordance with an added feature of the invention, the at least one storage element includes the first reduction device for the reduction of nitrogen monoxide to form ammonia.

This can, in particular, be obtained in that a honeycomb body with a corresponding coating is used as a storage element and/or first reduction device. The coating can, in particular, be a storage reduction coating in which the nitrogen monoxides are stored in the form of nitrites and/or nitrates and can be released through the use of a reducing agent.

In accordance with an additional feature of the invention, the at least one honeycomb body includes a first reduction catalyst coating. It is thus possible, in particular in a simple way, by combining the first reduction catalyst coating with the storage coating for storing nitrogen monoxide, to combine the first reduction device with the storage element.

In accordance with yet another feature of the invention, a reactor for generating a hydrogen-containing gas is provided. The reactor can be connected to the first reduction device. A reactor of this type can, in particular, generate a synthesis gas or cracked gas from a hydrocarbon-containing starting material such as, for example, a fuel of the internal combustion engine. The capacity for connection can be obtained, for example, through the use of a correspondingly-constructed valve, so that the reactor can be connected to the first reduction device but need not be permanently connected thereto. It is thus possible, in particular, on one hand to obtain highly precise control of the reduction medium addition for the reduction of nitrogen monoxide to form ammonia, and on the other hand to prevent substances from being discharged from the exhaust gas system through the corresponding connection.

In accordance with yet a further feature of the invention, the first reduction device can be connected to an exhaust line of an internal combustion engine.

The connectibility can be ensured, for example, through the use of a corresponding valve. As a result of the connectibility, the first reduction device can be connected to the exhaust line, although a permanent connection is not necessary. It is then possible, in particular, for the first reduction device to be connected to the exhaust line when it is operated in such a way that ammonia is generated. The second reduction device is then particularly preferably already provided in the exhaust line downstream of the connection to the first reduction device.

In accordance with a concomitant feature of the invention, during operation of a system with at least two gas lines, with a storage element and a first reduction device in each gas line, it is possible for a total of only a single second reduction device to be provided. In this case, the two gas lines are operated alternately, so that in each case a sorption, that is to say a temporary storage of nitrogen oxides, takes place in the storage element in a first gas line, while a desorption of the stored nitrogen oxide takes place in parallel in the second gas line. The desorbed NO_{X} can then be converted to ammonia in the second gas line. The desorption preferably takes place in an exhaust gas flow which contains as low an oxygen proportion as possible, since the use of the reducing agent which is necessary for the reduction of NO_{X} to form ammonia can be reduced. The two gas lines can be merged upstream of the second reduction device, so that in the case of a continuous alternating operation of the two gas lines, the second reduction device can be supplied at all times with ammonia as a reducing agent for the selective catalytic reduction of nitrogen oxides. At least the second reduction device is particularly preferably provided in the exhaust strand.

It is fundamentally possible both in the case of the method according to the invention as well as in the case of the device according to the invention, for further exhaust gas conversion components such as, in particular, oxidation catalytic converters, three-way catalytic converters, storage catalytic converters for certain components such as, for example, hydrocarbons or nitrogen oxides, particulate filters, in particular open and/or closed particulate filters, and the like to be provided.

An embodiment of an automobile which is provided with a diesel engine that includes a device according to the invention having the above-disclosed details, is also particularly preferable. The advantages and details disclosed above in connection with the method according to the invention can be applied and transferred in the same way to the device according to the invention. This also applies to advantages and details which have been disclosed in connection with the device according to the invention. These can be applied and transferred in the same way to the method according to the invention.

Other features which are considered as characteristic for the invention are set forth in the appended claims.

Although the invention is illustrated and described herein as constructed in a method and a device for providing ammonia in an exhaust gas flow of an internal combustion engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic and block diagram of a first exemplary embodiment of a device according to the invention;

FIG. 2 is a schematic and diagrammatic view of a second exemplary embodiment of a device according to the invention; and

FIG. 3 is a perspective view of a honeycomb body.

### DETAILED DESCRIPTION OF THE INVENTION

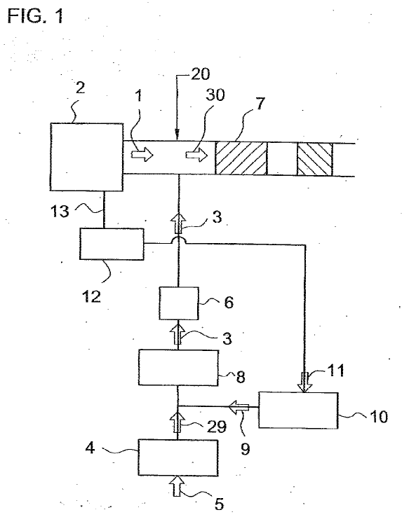

Referring now to the figures of the drawings in detail and first, particularly, to FIG. 1 thereof, there is seen an exemplary embodiment of a device according to the invention for providing ammonia in an exhaust gas flow 1 of an internal combustion engine 2. The exhaust gas flow 1 is denoted as an arrow. In this case, a gas flow 29 including nitrogen monoxide (NO) is generated in a plasma generator 4. For this purpose, the plasma generator 4 is preferably supplied with an oxygen-containing gas flow 5 as an operating gas which, in particular, at least partially includes air. The plasma generator 4 generates a plasma which includes radicals, in particular oxygen radicals, that serve to convert nitrogen (N₂) to form nitrogen oxides (NO_{X}). In this case, the plasma generator 4 is preferably constructed and operated in such a way that a shift of reaction equilibriums of the reaction for the generation of nitrogen oxides (NO_{X}) takes place in the direction of a generation preferably of nitrogen monoxide (NO). In addition, a first reduction device 6 is provided which can be or is connected to the plasma generator 4. In the first reduction device 6, a reduction of nitrogen monoxide (NO) to form ammonia (NH₃) takes place in a first gas flow 3, so that the first gas flow 3 contains ammonia after leaving the first reduction device. Ammonia can be used, in particular, as a reducing agent for the reduction of nitrogen oxides in the exhaust gas of an internal combustion engine.

In addition, a second reduction device 7 is provided in an exhaust line 20. A selective reduction of nitrogen oxides (NO_{X}) can take place in the second reduction device 7. The first gas flow 3, which now contains ammonia after the generation of the ammonia in the first reduction device 6 and the mixture with the exhaust gas flow 1, is introduced into a mixing flow 30 in the second reduction device 7. In this case, the ammonia serves as a selective reducing agent, which preferably reduces nitrogen oxides.

In addition, at least one storage element 8 is provided. The storage element 8 can, in particular, be constructed as a honeycomb body. The storage element preferably includes a coating for temporarily storing nitrogen oxides (NO_{X}). The storage element 8 is provided downstream of the plasma generator 4, in particular between the plasma generator 4 and the second reduction device 7, and preferably also between the plasma generator 4 and the first reduction device 6. It is thus possible for at least a part of the nitrogen monoxide (NO) which is contained in the gas flow 29 that leaves the plasma generator 4 to be temporarily stored in the storage element 8. The storage can take place, in particular, through the use of chemisorption and/or physisorption. In any case, the storage element 8, or a corresponding coating of the storage element 8, is selected in such a way that the storage of the nitrogen monoxide (NO) is reversible, that is to say that the stored nitrogen monoxide (NO) can be at least partially supplied to the first gas flow 3 in the event of a change of one or more physical and/or chemical conditions. This can take place, for example, in that nitrogen monoxide (NO) is chemically bonded in the storage element 8 so as to form nitrites and/or nitrates. In the case of providing a, for example, hydrogen-containing gas 9 which flows through the storage element 8 at least at times, reactions can occur in which ammonia (NH₃) is formed directly from the nitrate or nitrite groups. In this case, the first reduction device 6 and the storage element 8 can preferably be formed together in a single component, for example by virtue of a honeycomb body being provided with a corresponding reduction storage coating. The hydrogen-containing gas 9 can, in particular, be generated in a corresponding reactor 10 from a hydrocarbon-containing starting material 11 through the use of partial oxidation. The hydrocarbon-containing starting material 11 can include fuel, in particular, for example diesel fuel, with which the internal combustion engine 2 is also operated. For this purpose, the reactor 10 can preferably be connected to a corresponding fuel tank 12. This can, in particular, be the same fuel tank 12 which is connected by a fuel line 13 to the internal combustion engine 2.

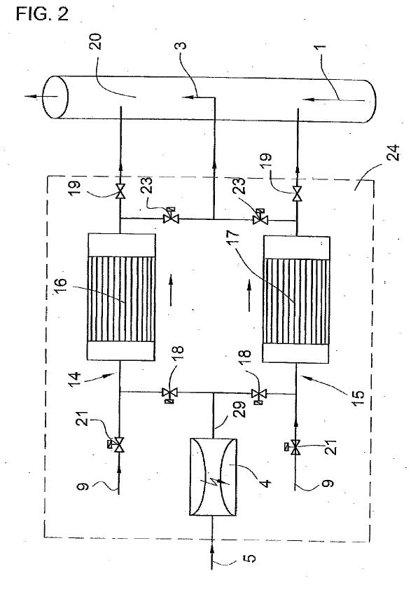

FIG. 2 diagrammatically and schematically shows a second exemplary embodiment of a device according to the invention. The device includes a plasma generator 4 into which an oxygen-containing gas 5 flows as an operating gas. The oxygen-containing gas 5 is preferably air or an exhaust gas partial flow, which is mixed with air. A certain proportion of nitrogen monoxide is generated in the plasma generator 4, as described above. In this case, the plasma generator 4 is activated and constructed in such a way that, in the reactions which take place, the reaction equilibrium is in each case shifted in such a way that preferably nitrogen monoxide is generated. An NO-containing gas flow 29 leaves the plasma generator 4. The gas flow 29 contains nitrogen monoxide (NO) which has been generated by the plasma generator 4. The plasma generator 4 is connected to a first gas line, leg or strand 14 and a second gas line, leg or strand 15. The first gas line 14 includes a first storage reduction device 16, while the second gas line 15 includes a second storage reduction device 17. The storage reduction devices 16, 17 are constructed in each case so as to include the function of the first reduction device 6 and the function of the storage element 8. The storage reduction devices 16, 17 are particularly preferably constructed as honeycomb bodies which include a corresponding storage reduction coating.

The plasma generator 4 can be connected to the first gas line 14 and/or to the second gas line 15 through the use of two valves 18. Below, consideration is now given firstly to a situation in which the first valves 18 are operated in such a way that the nitrogen-monoxide-containing gas flow 29 that leaves the plasma generator 4 flows only through the first gas line 14. In the first gas line 14, a storage of at least a part of the nitrogen monoxide contained in the gas flow 29 takes place in the first storage reduction device 16. The storage can take place as described above through the use of chemisorption and/or physisorption. In this case, the formation of a corresponding coating of the first storage reduction device 16 in which at least a chemisorption and/or physisorption of the nitrogen monoxide takes place through the use of the formation of nitrite and/or nitrate groups is preferable. In this case, the alkaline storage component of the storage reduction coating of the first storage reduction device 16 is selected in such a way that preferably nitrites are formed. The substantially nitrogen-monoxide-free residual gas which has left the first storage reduction device 16 is introduced through a second valve 19 into the exhaust line 20.

At the same time, in the second gas line 15, which is situated parallel to the first gas line 14, a reduction of the nitrogen monoxide stored in the second storage reduction device 17 takes place to form ammonia. For this purpose, a hydrogen-containing gas 9 is introduced through the use of a corresponding third valve 21 into the second storage reduction device 17. The hydrogen-containing gas 9 can, in particular, be generated, as described above, as a cracked gas or synthesis gas from fuel which contains hydrocarbons. It is, for example, possible for this purpose to use the same fuel with which the internal combustion engine 2 is also operated. The fuel is preferably converted in a corresponding non-illustrated reactor 10. The hydrogen-containing gas 9 flows through the second storage reduction device 17. In this case, a reaction of the hydrogen with the nitrate and nitrite groups takes place so as to form ammonia, water and OH-groups. The ammonia-containing first gas flow 3, which is generated in this way, is conducted through a correspondingly constructed fourth valve 23 into the exhaust line 20. The fourth valve 23 and the corresponding second valve 19 can, if appropriate, be constructed as a single component.

As described above, the first gas flow 3 can now mix with the exhaust gas flow 1 and be supplied downstream to a correspondingly constructed catalytic converter. The latter can, in particular, be a non-illustrated second reduction device 7 in which nitrogen oxides are reduced by the ammonia as a selective reducing agent. If the nitrogen monoxide storage device of the second storage reduction device 17 is substantially emptied in this way, the first valves 18, the second valves 19, the third valves 21 and/or the fourth valves 23 are switched in such a way that the gas flow 29 which leaves the plasma generator 4 now flows through the second gas line 15 and therefore leads to a renewed storage of nitrogen monoxide in the second storage reduction device 17. Correspondingly, an emptying of the nitrogen monoxide storage device in the first storage reduction device 16 now takes place, through the use of a hydrogen-containing gas flow 9 which flows through the corresponding third valve 21 into the first gas line 14, so as to form a first gas flow 3, which is introduced through the use of a corresponding fourth valve 23 into the exhaust line 20. The reactions, which have taken place or take place in this case, take place as described above, likewise in the first storage reduction device 16.

All of the components shown herein, that is to say in particular the plasma generator 4, the first storage reduction device 16 and the second storage reduction device 17, as well as the first valves 18, the second valves 19, the third valves 21 and the fourth valves 23, can preferably be constructed as a common module 24. The module 24 can particularly advantageously be connected in a simple way to the exhaust line 20. It is now possible, in particular, to create a module 24 which, for example, serves as a retrofit device for on-board ammonia production, instead of for urea and/or urea solution storage in an automobile. Corresponding modules 24 can thus advantageously also be installed in already-existing systems.

In an advantageous refinement, the module 24 can be heated through the use of corresponding non-illustrated heating elements. In this case, it is possible, in particular, for corresponding electric heating elements to be provided. The basic heat in the module 24 is already provided by the exhaust gas of the plasma generator 4. The temperature during operation of the module 24 is preferably in a range of from 250 to 300° C.

If, for example, 10 g of nitrogen monoxide per hour should be stored on the storage reduction devices 16, 17, the latter can, for example, include honeycomb bodies with volumes of approximately 200 ml in each case. In a device of this type, a corresponding switch, so that the gas flow 29 leaving the plasma generator 4 flows through the first gas line 14 or the second gas line 15, can take place, for example, in each case after one minute.

The oxygen-containing gas flow 5, which flows into the plasma generator 4, can preferably also be pre-heated. Pre-heating up to 80 to 100° C., in particular to approximately 100° C., is particularly advantageous. As a result of the pre-heating of the oxygen-containing gas flow 5, it is advantageously possible for a sulfur dioxide absorber to be operated upstream of the plasma generator 4. The sulfur dioxide absorber can, in particular, serve to prevent contamination of the storage reduction devices 16, 17.

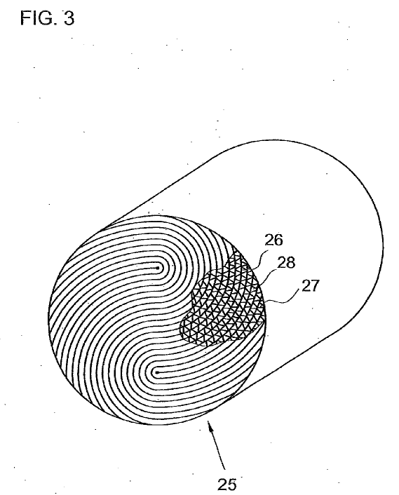

FIG. 3 diagrammatically shows a honeycomb body 25 which can be used, in particular, as a carrier body for the storage element 8, the reactor 10, the first reduction device 6, the second reduction device 7, the first storage reduction device 16 and/or the second storage reduction device 17. In the present exemplary embodiment, the honeycomb body 25 is formed from a stack of smooth metallic layers 26 and at least partially structured metallic layers 27 which form channels 28 through which a flow can pass through the honeycomb body. This is one possible example of a honeycomb body, although other honeycomb bodies are possible and fall within the scope of the invention. The stack has been wound in the same sense or direction about two points. The metallic layers 26, 27 form walls of the ducts 28. The walls can be provided with a coating. The latter includes, for example, a ceramic washcoat in which catalytically active components that include, for example, noble metals, are embedded. The coating has a correspondingly different construction depending on which of the above-specified elements of the honeycomb body 25 are used. For example, an alkaline coating can be provided if the honeycomb body 25 serves as a storage element 8. The coating would react with nitrogen monoxide so as to form nitrites and nitrates. Mixtures of coatings are also possible and fall within the scope of the invention.

The reactor 10, the storage element 8, the first storage reduction device 16 and the second storage reduction device 17 can be electrically heated and, in particular, include a honeycomb body which can be at least partially electrically heated.

A device according to the invention and a method according to the invention for the reduction of nitrogen oxides advantageously increases the efficiency of an on-board plasma-assisted ammonia generation, in particular in mobile applications such as motor vehicles, and reduces the increased fuel consumption required for this purpose in comparison with the devices and methods known from the prior art.

1. A method for providing ammonia in an exhaust gas flow of an internal combustion engine, the method comprising the following steps:
a) generating nitrogen monoxide with a plasma generator;
b) reversibly storing at least a part of the nitrogen monoxide;
c) reducing at least a part of the stored and/or generated nitrogen monoxide to form ammonia in a first gas flow; and
d) mixing the first gas flow with the exhaust gas flow.

2. The method according to claim 1, which further comprises feeding an operating gas, including a partial flow of the exhaust gas, to the plasma generator.

3. The method according to claim 1, which further comprises feeding an operating gas, including an oxygen-containing gas, to the plasma generator.

4. The method according to claim 3, which further comprises at least adding air to the plasma generator.

5. The method according to claim 1, which further comprises carrying out an at least partial supply and/or release of the stored nitrogen monoxide in the first gas flow before and/or during step c).

6. The method according to claim 1, which further comprises carrying out the storing step in a storage element.

7. The method according to claim 1, which further comprises carrying out the storing step by physisorption and/or chemisorption.

8. The method according to claim 1, which further comprises using a hydrogen-containing gas in step c).

9. The method according to claim 8, which further comprises generating the hydrogen-containing gas from a hydrocarbon-containing starting material.

10. The method according to claim 1, which further comprises carrying out the storing step in first and second storage elements operated in parallel, by temporarily storing nitrogen monoxide in the first storage element, and providing nitrogen monoxide to and/or releasing nitrogen oxides from the first gas flow in the second storage element.

11. A device for providing ammonia in the exhaust gas of an internal combustion engine, the device comprising:
at least one plasma generator for generating nitrogen monoxide;
at least one first reduction device to be connected to said plasma generator for the reduction of nitrogen monoxide to form ammonia; and
at least one storage element for storing nitrogen monoxide, said at least one storage element being disposed between said at least one plasma generator and said at least one first reduction device.

12. The device according to claim 11, wherein said at least one storage element is a honeycomb body with a storage coating.

13. The device according to claim 12, wherein said at least one storage element includes said first reduction device for the reduction of nitrogen monoxide to form ammonia.

14. The device according to claim 13, wherein said at least one honeycomb body includes a first reduction catalyst coating.

15. The device according to claim 11, which further comprises a reactor, to be connected to said first reduction device, for generating a hydrogen-containing gas.

16. The device according to claim 11, wherein said first reduction device is connected to an exhaust line of an internal combustion engine.

17. The device according to claim 11, which further comprises a first gas line and a second gas line each connected to said plasma generator, said storage element being one of two storage elements, said first reduction device being one of two first reduction devices, and each of said gas lines including a respective one of said two storage elements and a respective one of said two first reduction devices.

18. The device according to claim 11, which further comprises a second reduction device, to be connected to said first reduction device, for a selective reduction of nitrogen oxides.
